(19) United States
(12) Patent Application Publication
(10) Pub. No.: US 2009/0105618 A1
(43) Pub. Date: Apr. 23, 2009

(54) SPA CHAIR WITH PHYSICAL MASSAGE ELEMENTS

(76) Inventor: Lan Van Ta, Rancho Cucamonga, CA (US)

Correspondence Address: PATENT VENTURE GROUP, 10788 CIVIC CENTER DRIVE, SUITE 215, RANCHO CUCAMONGA, CA, 91730, US

(21) Appl. No.: 11/875,439

(22) Filed: Oct. 19, 2007

(51) Int. Cl. A61H 37/00

(52) U.S. Cl. 601/49; 4/622; 4/638; 601/46

(57) ABSTRACT

An invention is provided for a spa chair base suitable for use with any suitable seat. The spa chair base includes a pedicure basin defined by a plurality of sidewalls attached to a bottom portion, where the bottom portion and the plurality of sidewalls define an inner volume capable of containing a liquid to a particular liquid level. Disposed in the bottom portion of the pedicure basin is a physical massage element capable of providing a physical massage to a user. In addition, a waterproof physical massage element liner is attached to the pedicure basin and disposed between the physical massage element and the inner volume of the pedicure basin. The physical massage elements can utilize vibration, inflatable bladders, rollers, or any other type of massage element that provides a physical massage utilizing more than water pressure.

### CROSS REFERENCE TO RELATED APPLICATIONS

This application is related to U.S. patent application Ser. No. 11/840,197, filed Aug. 16, 2007, and entitled “Method and Apparatus for Disposable Spa Chair Pedicure Basin Sanitation,” which is incorporated herein be reference.

### BACKGROUND OF THE INVENTION

1. Field of the Invention

This invention relates generally to a spa chair, and more particularly to a spa chair having physical massage elements for lower legs and feet.

2. Description of the Related Art

Professional salons today allow customers to receive numerous services, such as facials, manicures, and pedicures. To facilitate these services, spa chairs are often used to allow clients to sit and relax while they receive facials, manicures, and pedicures. Such spa chairs often include a pedicure basin at the foot of the chair to facilitate pedicure services and foot massages. The pedicure basin generally includes water pressure jets for inducing water agitation to massage the client's feet. To provide water pressure, conventional pedicure basins typically circulate water from the interior of the pedicure basin using external piping and a water pump, as illustrated in FIG. 1.

FIG. 1 is a schematic diagram showing a conventional pedicure massage system 100 providing water agitation using exterior piping. The conventional pedicure massage system 100 includes a pedicure basin 102, pressure jets 104, and a pump 106 connected to a basin intake 108 and water jet pipes 110. In addition, a drain 112 generally is situated on the bottom floor of the pedicure basin 102 to allow water to drain out of the pedicure massage system 100.

In operation, the drain 112 is closed and the pedicure basin 102 is filled with water. Once the pedicure basin 102 is filled, the pump 106 is turned on to begin water agitation. In the exemplary conventional pedicure massage system 100, the pump 106 draws water out of the pedicure basin 102 via the basin intake 108. The pump 106 then pumps the water through the water jet pipes 110 to the pressure jets 104, which send the water back into the pedicure basin 102. In this manner, the water flowing out of the pressure jets 104 can provide massaging action when a user places their feet into the pedicure basin 102. When the massage is complete, the water present in the pedicure basin 102 can be drained by opening the drain 112, which allows the water present in the pedicure basin 102 to drain out of the pedicure massage system 100.

However, although water is agitated to provide a sense of massage to a client's feet, the water does not provide the same physical massage that is experienced when having a physical element, such as a masseuse's hands, physically massage the client. Hence, the muscle relaxing effect introduced via a non-water jet physical massage element generally cannot be had utilizing prior art spa chairs.

Moreover, although the water is drained out of the pedicure basin 102, water present in the basin intake 108, water jet pipes 110, and pump 106 cannot be drained out of the pedicure massage system 100. This remaining water generally contains unsanitary residue, including scale deposits, body oils, and other body fluids. As a result, when the pedicure massage system 100 is used for the next client, the water that remained in the basin intake 108, water jet pipes 110, and pump 106 after the prior use is circulated back into the pedicure basin 102. Thus, the next client to use the pedicure massage system 100 is exposed to the bacteria and other germs that may have been present in the remaining pipe water because of the prior client.

In view of the foregoing, there is a need for spa chair systems that include physical massage elements. The physical massage elements should provide an enhanced massage to the user, and still enable the user to simultaneously experience the sensation of swirling or agitated water during the massage. In addition, protection should be provided against exposure to bacteria and other germs that may have been present in the remaining pipe water because of a prior client.

### SUMMARY OF THE INVENTION

Broadly speaking, the present invention addresses these needs by providing a spa chair having physical massage elements capable of withstanding emersion in water via a waterproof physical massage element liner. For example, in one embodiment a spa chair base suitable for use with any suitable seat is disclosed. The spa chair base includes a pedicure basin defined by a plurality of sidewalls attached to a bottom portion, where the bottom portion and the plurality of sidewalls define an inner volume capable of containing a liquid to a particular liquid level. Disposed in the bottom portion of the pedicure basin is a physical massage element capable of providing a physical massage to a user. In addition, a waterproof physical massage element liner is attached to the pedicure basin and disposed between the physical massage element and the inner volume of the pedicure basin. The physical massage elements can utilize vibration, inflatable bladders, rollers, or any other type of massage element that provides a physical massage utilizing more than water pressure.

In a further embodiment, an additional spa chair base suitable for use with any suitable seat is disclosed. As above, the spa chair base includes a pedicure basin defined by a plurality of sidewalls attached to a bottom portion, where the bottom portion and the plurality of sidewalls define an inner volume capable of containing a liquid to a particular liquid level. Disposed in a sidewall of the pedicure basin is a physical massage element capable of providing a physical massage to a user. In addition, a water proof physical massage element liner is attached to the pedicure basin and disposed between the physical massage element and the inner volume of the pedicure basin. Optionally, an additional liner can be disposed in the pedicure basin, between the physical massage element liner and the inner volume of the pedicure basin. In this case, the additional liner can include gas piping disposed within the inner volume of the liner that defines a gas-carrying conduit, which includes a plurality of openings through which gas can pass into the inner volume of the liner.

Also, a spa chair is disclosed in an additional embodiment of the present invention. The spa chair includes a seat, a base coupled to the seat, and a pedicure basin connected to the base. The pedicure basin is defined by a plurality of sidewalls attached to a bottom portion, where the bottom portion and the plurality of sidewalls define an inner volume capable of containing a liquid to a particular liquid level. Disposed in the pedicure basin is a physical massage element capable of providing a physical massage to a user. In addition, a waterproof physical massage element liner is attached to the pedicure basin and disposed between the physical massage element and the inner volume of the pedicure basin. For example, the physical massage element can be a foot physical massage element disposed in the bottom portion of the pedicure basin. In addition, a calf physical massage element can be included that is disposed in a sidewall of the pedicure basin.

In this manner, embodiments of the present invention advantageously allow a user to experience a physical massage that is more than mere water jets or air jets while having their calves and feet soaked in water or some other liquid. Since the physical massage elements of the embodiments of the present invention are protected from the harmful effects of being submerged in liquid, the user can experience the full benefits of a pedicure basin while enjoying a physical massage of their calves and feet. In addition, embodiments of the present invention can advantageously leave the pedicure basin clean after use having not had any water directly in contact with it when the pedicure basin gas jet liner is used. Moreover, there is little or no clean up because the pedicure basin gas jet liner can be thrown away when constructed of disposable material. Other aspects and advantages of the invention will become apparent from the following detailed description, taken in conjunction with the accompanying drawings, illustrating by way of example the principles of the invention.

### BRIEF DESCRIPTION OF THE DRAWINGS

The invention, together with further advantages thereof, may best be understood by reference to the following description taken in conjunction with the accompanying drawings in which:

FIG. 1 a schematic diagram showing a conventional pedicure massage system providing water agitation using exterior piping;

FIG. 2 is a diagram showing a spa chair having physical massage elements, in accordance with an embodiment of the present invention;

FIG. 3 is a top view of the spa chair having feet physical massage elements, in accordance with an embodiment of the present invention;

FIG. 4 is a diagram showing a top view of the spa chair having feet physical massage elements protected by a physical massage element liner, in accordance with an embodiment of the present invention;

FIG. 5 is a front cross sectional view of the spa chair showing an exemplary vibration based foot physical massage element, in accordance with an embodiment of the present invention;

FIG. 6 is a front cross sectional view of the spa chair showing an exemplary bladder based foot physical massage element, in accordance with an embodiment of the present invention;

FIG. 7 is a front cross sectional view of the spa chair showing an exemplary bladder based calve physical massage element, in accordance with an embodiment of the present invention;

FIG. 8 is a diagram showing front cross sectional view of the spa chair showing an exemplary bladder based calve physical massage element protected by a physical massage element liner, in accordance with an embodiment of the present invention; and

FIG. 9 is a cross sectional view showing the pedicure basin gas jet liner situated within the pedicure basin of a spa chair, in accordance with an embodiment of the present invention.

### DETAILED DESCRIPTION OF THE PREFERRED EMBODIMENTS

An invention is disclosed for a spa chair system that includes physical massage elements. Broadly speaking, embodiments of the present invention provide physical massage elements covered by a waterproof material capable of protecting the electrical and mechanical elements of the physical massage elements of the spa chair. In this manner, the physical massage elements massage the user's feet and calves, which are in physical contact with the physical massage elements while the user's feet and calves are submerged in a water-filled pedicure basin of the spa chair. The pedicure basin of the spa chair can also include water jets, as described above, and/or a disposable spa chair pedicure basin gas jet liner, as described in co-pending U.S. patent application Ser. No. 11/840,197, filed Aug. 16, 2007, and entitled “Method and Apparatus for Disposable Spa Chair Pedicure Basin Sanitation,” which is incorporated herein be reference.

In the following description, numerous specific details are set forth in order to provide a thorough understanding of the present invention. It will be apparent, however, to one skilled in the art that the present invention may be practiced without some or all of these specific details. In other instances, well known process steps have not been described in detail in order not to unnecessarily obscure the present invention.

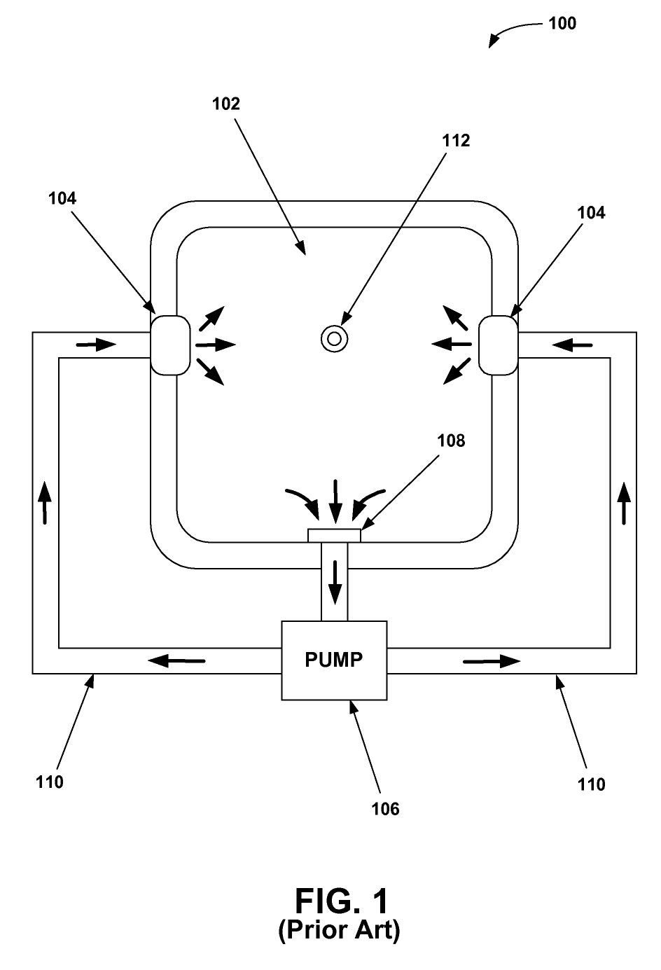

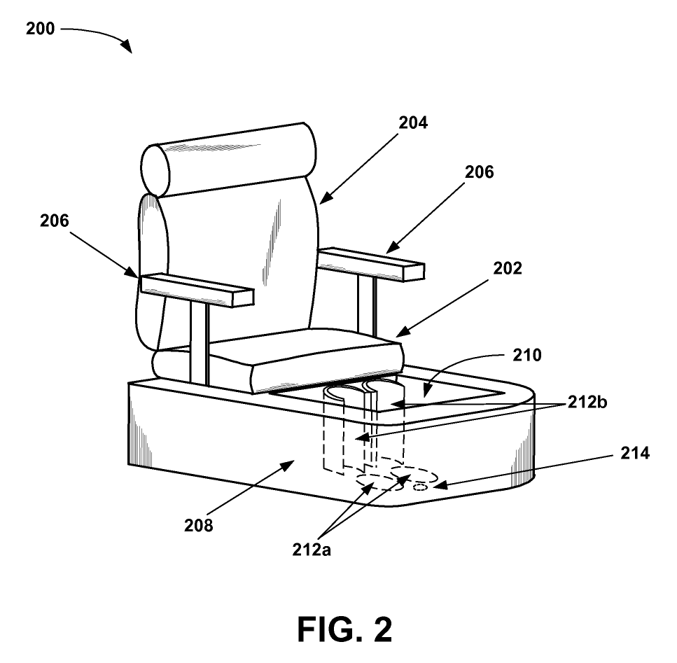

FIG. 1 was described in terms of the prior art. FIG. 2 is a diagram showing a spa chair 200 having physical massage elements, in accordance with an embodiment of the present invention. The spa chair 200 includes a seat 202 connected to a backrest 204 and a pair of arm rests 206. The seat 202 of the spa chair 200 is further connected to a spa chair base 208, which also houses a pedicure basin 210. The pedicure basin 210 is located within the spa chair base 208, below and forward of the seat 202. The pedicure basin 210 is designed to hold a liquid, such as water, and generally includes a drain 214 in the bottom panel of the pedicure basin 210. A faucet (not shown) can optionally be attached to the pedicure basin 210 to allow liquid to be easily flowed into the pedicure basin 210.

Disposed in the pedicure basin 210 are physical massage elements 212a and 212a. In the example of FIG. 2, feet physical massage elements 212a are disposed in the bottom portion of the pedicure basin 210, and calf physical massage elements 212a are disposed in the sidewall of the pedicure basin 210 below the seat 202. As will be explained in greater detail subsequently, the physical massage elements 212a and 212a can be any massage element capable of providing a physical massage using more than water pressure when a user's feet or lower legs are placed in physical contact with the physical massage element. Examples of physical massage elements 212a and 212a can include elements that provide a physical massage utilizing vibration, elements that provide a physical massage utilizing inflatable bladders, elements that provide a physical massage utilizing rollers, and any other type of massage element that provides a physical massage utilizing more than water pressure. In this manner, embodiments of the present invention provide a user with a greater and more satisfying massage than is capable utilizing water jets alone.

To protect the physical massage elements from the harmful effects of water, a massage element liner is disposed between the physical massage elements and the inner volume of the pedicure basin 210. As mentioned above, the message element liner is formed from a waterproof material capable of preventing water present in the pedicure basin 210 from coming into contact with the physical massage elements 212a and 212a. Although FIG. 2 shows both physical massage elements 212a and 212a present in the pedicure basin 210, it should be noted that embodiments of the present invention can be utilized with only the feet physical massage elements 212a, only the calf physical massage elements 212a, or both the feet physical massage elements 212a and the calf physical massage elements 212a.

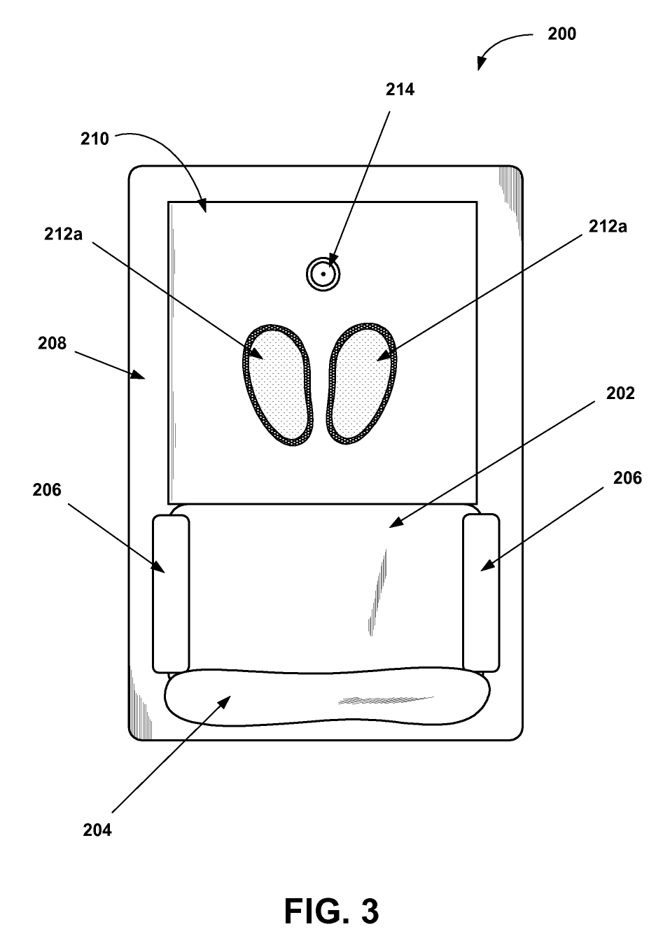

FIG. 3 is a top view of the spa chair 200 having feet physical massage elements 212a, in accordance with an embodiment of the present invention. Similar to FIG. 2, the spa chair 200 of FIG. 3 includes a seat 202 connected to a backrest 204 and a pair of arm rests 206. The seat 202 of the spa chair 200 is further connected to a spa chair base 208, which also houses a pedicure basin 210 designed to hold a liquid, such as water, and generally includes a drain 214 in the bottom panel of the pedicure basin 210. A faucet (not shown) can optionally be attached to the pedicure basin 210 to allow liquid to be easily flowed into the pedicure basin 210.

Disposed in the pedicure basin 210 are physical massage elements 212a. In the example of FIG. 3, feet physical massage elements 212a are disposed in the bottom portion of the pedicure basin 210. As mentioned previously, the physical massage elements 212a can be any massage element capable of providing a physical massage using more than water pressure when a user's feet are placed in physical contact with the physical massage element. For example, the physical massage element 212a can be a massage element based on vibration. That is, when the user places their feet on the physical massage element 212a, the physical massage element 212a vibrates at a relatively fast frequency so as to provide a pleasant physical massage to the user's feet. Other exemplary physical massage elements can be, for example, inflatable bladder that inflate and deflate in a manner so as to provide a physical massage to the user's feet when placed in physical contact with the physical massage element 212a.

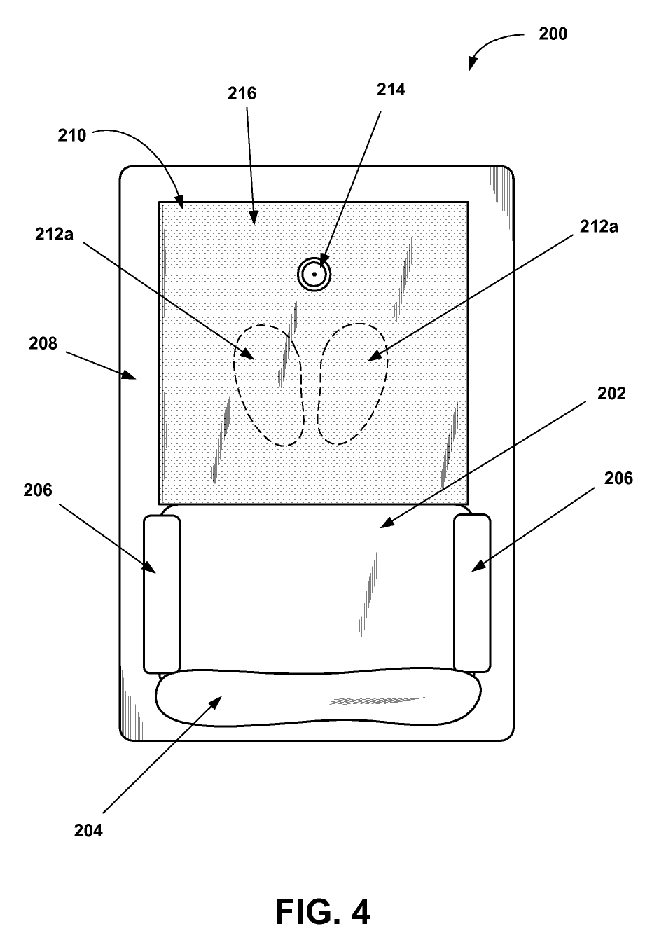

As mentioned previously, the physical massage elements 212a are general utilized while water, or a similar liquid, is present in the pedicure basin 210, and thus generally are operated while submerged in water. To protect the physical massage elements from the detrimental effects of the water present in the pedicure basin, embodiments of the present invention utilize a waterproof physical massage element liner to protect the physical massage elements, as illustrated in FIG. 4.

FIG. 4 is a diagram showing a top view of the spa chair 200 having feet physical massage elements 212a protected by a physical massage element liner, in accordance with an embodiment of the present invention. The spa chair 200 of FIG. 4 includes a seat 202 connected to a backrest 204 and a pair of arm rests 206. The seat 202 of the spa chair 200 is further connected to a spa chair base 208, which also houses a pedicure basin 210 designed to hold a liquid, such as water, and generally includes a drain 214 in the bottom panel of the pedicure basin 210. Located in the pedicure basin 210 are physical massage elements 212a. Disposed between the physical massage elements 212a and the inner volume of the pedicure basin 210 is a physical massage element liner 216.

As mentioned above, the physical message element liner 216 is formed from a waterproof material capable of preventing water present in the pedicure basin 210 from coming into contact with the physical massage elements 212a. In this manner, physical massage element liner 216 covers the physical massage elements 212a in a waterproof material capable of protecting the electrical and mechanical elements of the physical massage elements of the spa chair. In this manner, the physical massage elements 212a can massage the user's feet, which are in physical contact with the physical massage elements 212a while the user's feet are submerged in the water-filled pedicure basin 210 of the spa chair 200.

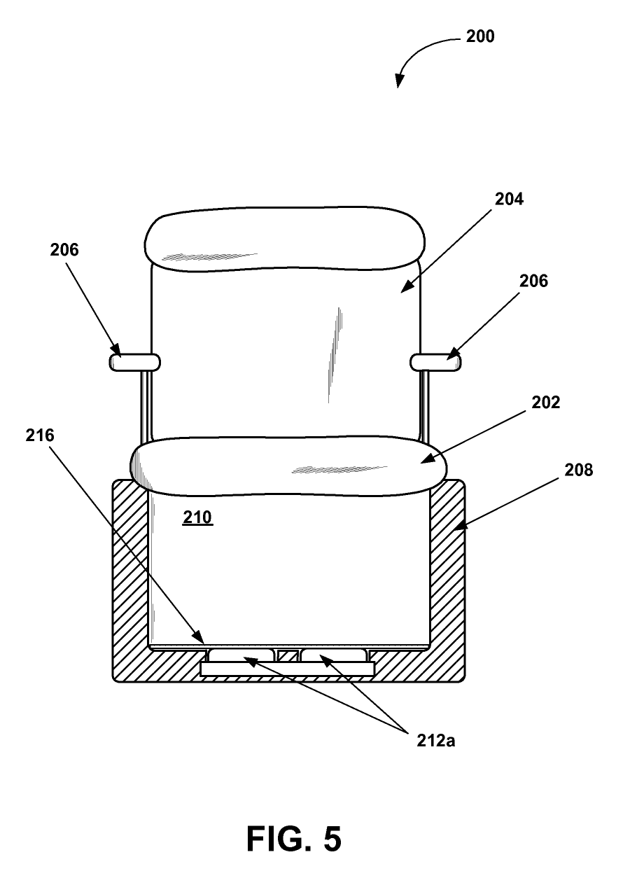

FIG. 5 is a front cross sectional view of the spa chair 200 showing an exemplary vibration based foot physical massage element 212a, in accordance with an embodiment of the present invention. The spa chair 200 includes a seat 202 connected to a backrest 204 and a pair of arm rests 206. The seat 202 of the spa chair 200 is further connected to a spa chair base 208, which also houses a pedicure basin 210 designed to hold a liquid, such as water. Located in the pedicure basin 210 is a vibration based physical massage elements 212a. In addition, a physical massage element liner 216 is disposed between the physical massage elements 212a and the inner volume of the pedicure basin 210.

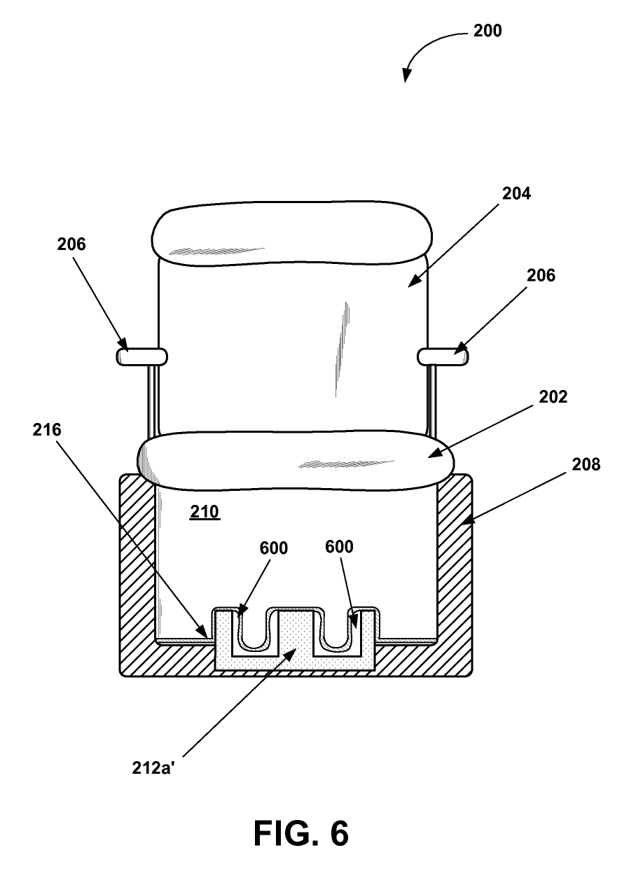

As mentioned above, in the example of FIG. 5 the physical massage element 212a is a vibration based physical massage element designed to provide a massaging sensation to the user's feet using vibration. As will be apparent to those skilled in the art after a careful reading of the present disclosure, the vibration action of the physical massage element 212a travels through the physical massage element liner 216 to the user's feet when the user's feet are placed on the physical massage element liner 216 above the physical massage element 212a. Since the physical massage element liner 216 is preferable manufactured from a flexible material, the physical massage element liner 216 can move with the physical massage element to transfer massage sensations to the user's feet, while still providing protection for the physical massage element 212a from water present in the pedicure basin 210. Although FIG. 5 illustrates use of a vibration based physical massage element 212a, it should be noted that other types of physical massage elements can be utilized with the embodiments of the present invention, such as bladder based massage elements as shown next with reference to FIG. 6.

FIG. 6 is a front cross sectional view of the spa chair 200 showing an exemplary bladder based foot physical massage element 212a′, in accordance with an embodiment of the present invention. The spa chair 200 includes a seat 202 connected to a backrest 204 and a pair of arm rests 206. The seat 202 of the spa chair 200 is further connected to a spa chair base 208, which also houses a pedicure basin 210 designed to hold a liquid, such as water. Located in the pedicure basin 210 is a bladder based physical massage elements 212a′. As before, a physical massage element liner 216 is disposed between the physical massage elements 212a′ and the inner volume of the pedicure basin 210.

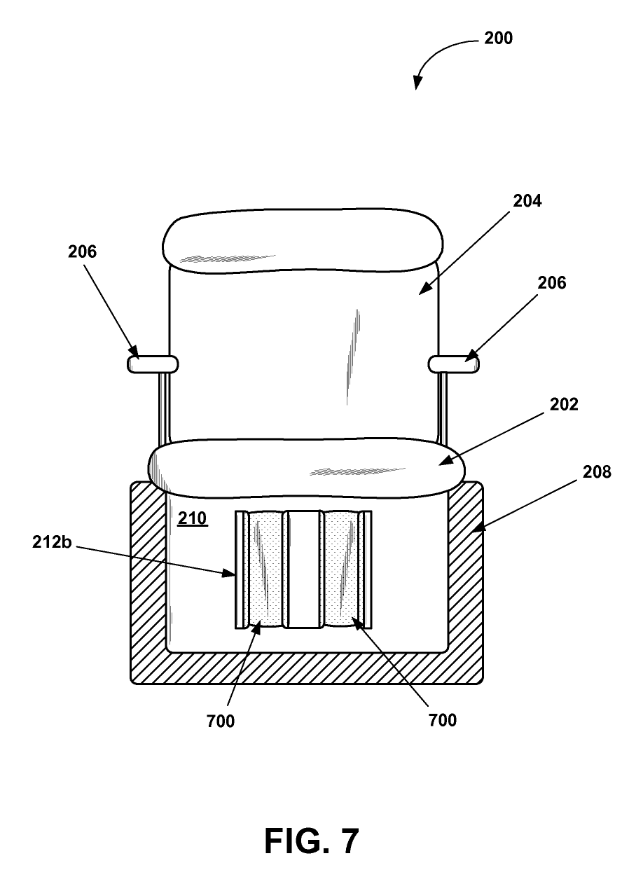

As mentioned above, in the example of FIG. 6 the physical massage element 212a′ is a bladder based physical massage element designed to provide a massaging sensation to the user's feet using inflation and deflation of bladders 600. In general, while the user's feet are present and in contact with the physical massage element 212a′, the bladders 600 are inflated to provide pressure to the user's feet and deflated to relieve that pressure. Thus, the inflation and deflation of the bladders 600 provide massaging action to the user's feet. As above, the massaging action of the physical massage element 212a′ travels through the physical massage element liner 216 to the user's feet when the user's feet are placed on the physical massage element liner 216 above and within the physical massage element 212a′. Since the physical massage element liner 216 is preferable manufactured from a flexible material, the physical massage element liner 216 can move with the bladders 600 to transfer massage sensations to the user's feet, while still providing protection for the physical massage element 212a′ from water present in the pedicure basin 210. In addition to physical massage elements for the user's feet, embodiments of the present invention can also be utilized with physical massage elements for the user's calves, as described next with reference to FIG. 7.

FIG. 7 is a front cross sectional view of the spa chair 200 showing an exemplary bladder based calve physical massage element 212a, in accordance with an embodiment of the present invention. The spa chair 200 includes a seat 202 connected to a backrest 204 and a pair of arm rests 206. The seat 202 of the spa chair 200 is further connected to a spa chair base 208, which also houses a pedicure basin 210 designed to hold a liquid, such as water.

Disposed in the pedicure basin 210 are physical massage elements 212a. In the example of FIG. 7, calf physical massage elements 212a are disposed in a sidewall of the pedicure basin 210, nearest the seat 202. As mentioned previously, the physical massage elements 212a can be any massage element capable of providing a physical massage using more than water pressure when a user's calves are placed in physical contact with the physical massage element 212a. For example, the physical massage element 212a can be a massage element based on bladders 700, similar to FIG. 6. The physical massage element 212a provides a massaging sensation to the user's calves using inflation and deflation of the bladders 700. In general, while the user's calves are present and in contact with the physical massage element 212a, the bladders 700 are inflated to provide pressure to the user's calves and deflated to relieve that pressure. Thus, the inflation and deflation of the bladders 700 provide massaging action to the user's calves.

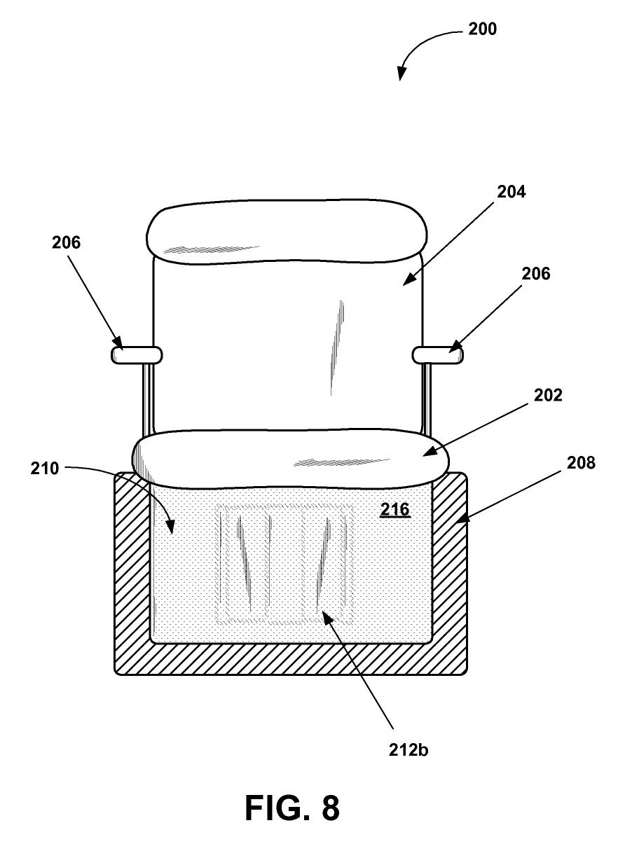

As mentioned previously, the physical massage elements 212a are general utilized while water, or a similar liquid, is present in the pedicure basin 210, and thus generally are operated while submerged in water. To protect the physical massage elements 212a from the detrimental effects of the water present in the pedicure basin 210, embodiments of the present invention utilize a waterproof physical massage element liner to protect the physical massage elements, as illustrated in FIG. 8.

FIG. 8 is a diagram showing front cross sectional view of the spa chair 200 showing an exemplary bladder based calve physical massage element 212a protected by a physical massage element liner 216, in accordance with an embodiment of the present invention. The spa chair 200 of FIG. 8 includes a seat 202 connected to a backrest 204 and a pair of arm rests 206. The seat 202 of the spa chair 200 is further connected to a spa chair base 208, which also houses a pedicure basin 210 designed to hold a liquid, such as water, and generally includes a drain 214 in the bottom panel of the pedicure basin 210. Located in the pedicure basin 210 are physical massage elements 212a. Disposed between the physical massage elements 212a and the inner volume of the pedicure basin 210 is a physical massage element liner 216.

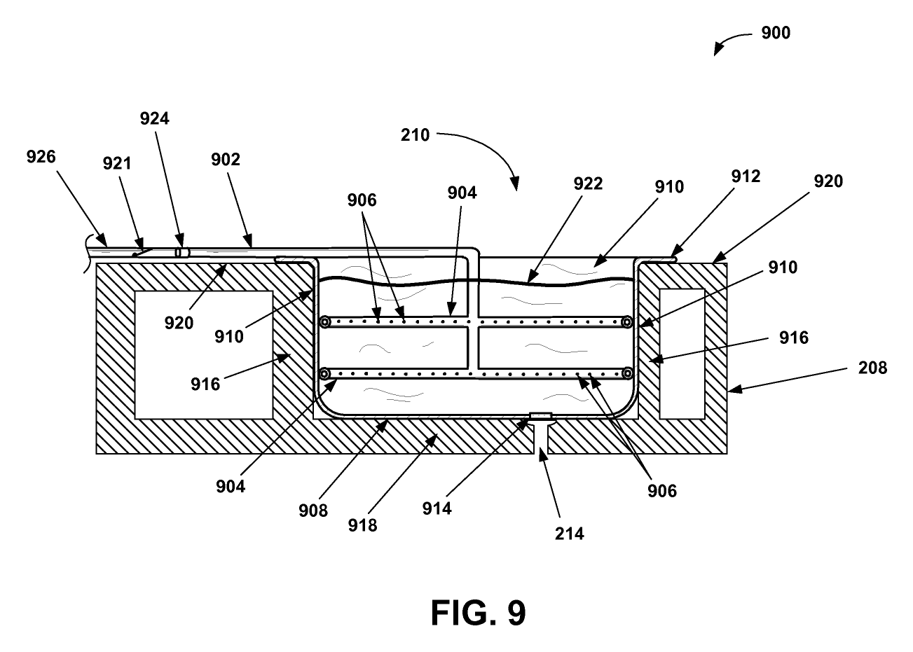

As mentioned above, the physical message element liner 216 is formed from a waterproof material capable of preventing water present in the pedicure basin 210 from coming into contact with the physical massage elements 212a. In this manner, physical massage element liner 216 covers the physical massage elements 212a in a waterproof material capable of protecting the electrical and mechanical elements of the physical massage elements of the spa chair. In this manner, the physical massage elements 212a can massage the user's calves, which are in physical contact with the physical massage elements 212a while the user's calves are submerged in the water-filled pedicure basin 210 of the spa chair 200. In one embodiment, the pedicure basin of the spa chair can also include a disposable spa chair pedicure basin gas jet liner, as described in co-pending U.S. patent application Ser. No. 11/840,197, filed Aug. 16, 2007, and entitled “Method and Apparatus for Disposable Spa Chair Pedicure Basin Sanitation,” which is incorporated herein be reference, and illustrated next with reference to FIG. 9.

FIG. 9 is a cross sectional view showing the pedicure basin gas jet liner 900 situated within the pedicure basin 210 of the spa chair, in accordance with an embodiment of the present invention. The pedicure basin 210 of the spa chair is generally formed in the spa chair base 208 and includes a bottom portion 918 and a plurality of sidewalls 916. The sidewalls 916 of the pedicure basin 210 end generally at the top section 920 of the spa chair base 208. An interior volume of the pedicure basin 210 is defined by the bottom portion 918 and sidewalls 916. At the bottom of the interior volume, and situated in the bottom portion 918 of the pedicure basin 210 is a basin drain 214, which allows liquid to escape the pedicure basin 210.

Within the interior volume of the pedicure basin 210 is situated a pedicure basin gas jet liner 900. The pedicure basin gas jet liner 900 includes a bottom portion 908, a plurality of sidewalls 910 and a top lip 912, which defines an open top. An interior volume is defined by the bottom portion 908 and sidewalls 910, which is capable of containing a liquid substantially to the top lip 912. Manufactured into the pedicure basin gas jet liner 900 is a liner gas supply hose 902 connected to gas jet piping 904, which includes a plurality of gas jet holes 906. Disposed in the bottom portion 908 of the pedicure basin gas jet liner 900, and positioned substantially over the basin drain 214 is a liner drain 914.

As illustrated in FIG. 9, the pedicure basin gas jet liner 900 conforms to the interior volume of the pedicure basin 210, with the bottom portion 908 of the pedicure basin gas jet liner 900 closely accommodating the bottom portion 918 of the pedicure basin 210, and the sidewalls 910 of the pedicure basin gas jet liner 900 closely accommodating the sidewalls 916 of the pedicure basin 210. Further, the top lip 912 of the pedicure basin gas jet liner 900 extends over the top section 920 of the spa chair base 208, which also defines an open top of the pedicure basin 210.

In operation, the pedicure basin gas jet liner 900 is placed into the pedicure basin 210. In addition, the liner gas supply hose 902 is attached to a gas hose nozzle 924. Once the pedicure basin gas jet liner 900 is in place, water can be introduced into the pedicure basin gas jet liner 900, which lines the pedicure basin 210. The water is introduced into the pedicure basin gas jet liner 900 to a particular liquid level, as indicated by the liquid level 922.

A gas supply can then be powered on to provide gas to the liner gas supply hose 902 via the spa chair gas supply hose 926 and gas hose nozzle 924. Optionally, a check valve 921 can be included as extra protection against liquid contaminating the gas system. The gas, for example air, is introduced into the gas jet piping 904 via the liner gas supply hose 902, and allowed to escape into the water present in the pedicure basin gas jet liner 900 via the gas jet holes 906 located in the gas jet piping 904. In this manner, a user is allowed to enjoy the benefits of an air jet foot massage.

Once the user is finished using the spa chair 200, the liner drain 914 located in the pedicure basin gas jet liner 900 can be opened to allow the water to escape into the basin drain 214 of the pedicure basin 210. Thereafter, the liner gas supply hose 902 is detached from the gas hose nozzle 924 and the pedicure basin gas jet liner 900 can be removed from the pedicure basin 210. In one embodiment, the pedicure basin gas jet liner 900 is constructed of a low cost disposable material, thus allowing the user to dispose of the pedicure basin gas jet liner 900 after use.

When the pedicure basin gas jet liner 900 is removed from the pedicure basin 210, the pedicure basin 210 is clean having not had any water directly in contact with it. Moreover, there is little or no clean up because the pedicure basin gas jet liner 900 can be thrown away when constructed of disposable material. Consequently, the spa chair 200 and pedicure basin 210 can be reused by the next client without the risk of being exposed to the bacteria and other germs that may have been introduced into the pedicure basin gas jet liner 300 water by the prior client.

Thus, embodiments of the present invention advantageously allow a user to experience a physical massage that is more than mere water jets or air jets while having their calves and feet soaked in water or some other liquid. Since the physical massage elements of the embodiments of the present invention are protected from the harmful effects of being submerged in liquid, the user can experience the full benefits of a pedicure basin while enjoying a physical massage of their calves and feet.

In addition, embodiments of the present invention can advantageously leave the pedicure basin clean after use having not had any water directly in contact with it when the pedicure basin gas jet liner is used. Moreover, there is little or no clean up because the pedicure basin gas jet liner can be thrown away when constructed of disposable material. Consequently, the spa chair and pedicure basin can be reused by the next client without the risk of being exposed to the bacteria and other germs that may have been introduced into the pedicure basin gas jet liner water by the prior client.

Although the foregoing invention has been described in some detail for purposes of clarity of understanding, it will be apparent that certain changes and modifications may be practiced within the scope of the appended claims. Accordingly, the present embodiments are to be considered as illustrative and not restrictive, and the invention is not to be limited to the details given herein, but may be modified within the scope and equivalents of the appended claims.

What is claimed is:

1. A spa chair base suitable for use with any suitable seat, comprising:
a pedicure basin defined by a plurality of sidewalls attached to a bottom portion, wherein the bottom portion and the plurality of sidewalls define an inner volume, the inner volume being capable of containing a liquid to a particular liquid level;
a physical massage element disposed in the bottom portion of the pedicure basin, the physical massage element capable of providing a physical massage to a user; and
a physical massage element liner attached to the pedicure basin and disposed between the physical massage element and the inner volume of the pedicure basin, wherein the physical massage element liner is a waterproof material.

2. A spa chair base as recited in claim 1, wherein the physical massage element provides massaging action based on vibration.

3. A spa chair base as recited in claim 1, wherein the physical massage element provides massaging action based on inflating and deflating bladders.

4. A spa chair base as recited in claim 1, wherein the physical massage element provides massaging action based on rollers.

5. A spa chair base as recited in claim 1, further comprising a liner disposed in the pedicure basin between the physical massage element liner and the inner volume of the pedicure basin.

6. A spa chair base as recited in claim 5, wherein the liner includes a plurality of sidewalls attached to the bottom portion, wherein the bottom portion and the plurality of sidewalls define an inner volume.

7. A spa chair base as recited in claim 6, wherein the liner further includes gas piping disposed within the inner volume of the liner, the gas piping defining a gas-carrying conduit, wherein the gas piping includes a plurality of openings through which gas can pass into the inner volume of the liner.

8. A spa chair base suitable for use with any suitable seat, comprising:
a pedicure basin defined by a plurality of sidewalls attached to a bottom portion, wherein the bottom portion and the plurality of sidewalls define an inner volume, wherein the inner volume is capable of containing a liquid to a particular liquid level;
a physical massage element disposed in a sidewall of the pedicure basin, the physical massage element capable of providing a physical massage to a user; and
a physical massage element liner attached to the pedicure basin and disposed between the physical massage element and the inner volume of the pedicure basin, wherein the physical massage element liner is a waterproof material.

9. A spa chair base as recited in claim 8, wherein the physical massage element provides massaging action based on vibration.

10. A spa chair base as recited in claim 8, wherein the physical massage element provides massaging action based on inflating and deflating bladders.

11. A spa chair base as recited in claim 8, wherein the physical massage element provides massaging action based on rollers.

12. A spa chair base as recited in claim 8, further comprising a liner disposed in the pedicure basin between the physical massage element liner and the inner volume of the pedicure basin.

13. A spa chair base as recited in claim 12, wherein the liner includes a plurality of sidewalls attached to the bottom portion, wherein the bottom portion and the plurality of sidewalls define an inner volume.

14. A spa chair base as recited in claim 13, wherein the liner further includes gas piping disposed within the inner volume of the liner, the gas piping defining a gas-carrying conduit, wherein the gas piping includes a plurality of openings through which gas can pass into the inner volume of the liner.

15. A spa chair, comprising:
a seat;
a base coupled to the seat;
a pedicure basin connected to the base, wherein the pedicure basin is defined by a plurality of sidewalls attached to a bottom portion, wherein the bottom portion and the plurality of sidewalls define an inner volume, the inner volume being capable of containing a liquid to a particular liquid level;
a physical massage element disposed in the pedicure basin, the physical massage element capable of providing a physical massage to a user; and
a physical massage element liner attached to the pedicure basin and disposed between the physical massage element and the inner volume of the pedicure basin, wherein the physical massage element liner is a waterproof material.

16. A spa chair as recited in claim 15, wherein the physical massage element is a foot physical massage element disposed in the bottom portion of the pedicure basin.

17. A spa chair as recited in claim 15, further comprising a calf physical massage element disposed in a sidewall of the pedicure basin.

18. A spa chair as recited in claim 15, further comprising a liner disposed in the pedicure basin between the physical massage element liner and the inner volume of the pedicure basin.

19. A spa chair as recited in claim 18, wherein the liner includes a plurality of sidewalls attached to the bottom portion, wherein the bottom portion and the plurality of sidewalls define an inner volume.

20. A spa chair as recited in claim 19, wherein the liner further includes gas piping disposed within the inner volume of the liner, the gas piping defining a gas-carrying conduit, wherein the gas piping includes a plurality of openings through which gas can pass into the inner volume of the liner.
